(19) United States
(12) Patent Application Publication
(10) Pub. No.: US 2020/0198594 A1
(43) Pub. Date: Jun. 25, 2020

(54) METHOD FOR OPERATING AN AUTONOMOUS TRANSPORTATION VEHICLE FLEET AND SERVICE MODULE FOR AN AUTONOMOUS TRANSPORTATION VEHICLE FLEET

(71) Applicant: VOLKSWAGEN AKTIENGESELLSCHAFT, Wolfsburg (DE)

(72) Inventors: Frank PETERSHAGEN, Hannover (DE); Henrik RÖHL, Braunschweig (DE); Phillip SCHMITZ, Braunschweig (DE); Sebastian GROBE, Braunschweig (DE); Kira WEIßBRICH, Braunschweig (DE); Maik OTREMBA, Braunschweig (DE); Eva-Maria KLEINEMAS, Verl (DE)

(73) Assignee: VOLKSWAGEN AKTIENGESELLSCHAFT

(21) Appl. No.: 16/718,611

(22) Filed: Dec. 18, 2019

(30) Foreign Application Priority Data
Dec. 20, 2018 (DE) 10 2018 222 640.7

(51) Int. Cl. B60S 5/02; G05D 1/02; B60S 3/04; B60L 53/60; G07C 5/08

(52) U.S. Cl. CPC B60S 5/02; G05D 1/0291; B60S 3/04; B60K 6/28; G05D 1/0276; G07C 5/0816; B60L 53/60

(57) ABSTRACT

A method for operating an autonomous transportation vehicle fleet with autonomously driven transportation vehicles which identifies a service requirement of at least one transportation vehicle of the transportation vehicle fleet; identifies a service action to be carried out on the transportation vehicle based on the service requirement identified for the transportation vehicle; identifies a suitable service station for performing the service action; autonomously drives the transportation vehicle to the identified service station; and autonomously performs the service action on the transportation vehicle in the service station. A service station for the transportation vehicles of an autonomous transportation vehicle fleet having a second communication module for communication with the transportation vehicles and/or a server of a fleet operator; a second control unit for identifying a service action to be carried out on a transportation vehicle; and at least one service module for autonomously performing a service action on the transportation vehicle.

### PRIORITY CLAIM

This patent application claims priority to German Patent Application No. 10 2018 222 640.7, filed 20 Dec. 2018, the disclosure of which is incorporated herein by reference in its entirety.

### SUMMARY

Illustrative embodiments relate to a method for operating an autonomous transportation vehicle fleet, in particular, a plurality of autonomously driven transportation vehicles of a car-sharing provider. Illustrative embodiments also relate to a service module for an autonomous transportation fleet vehicle, in particular, for an autonomous transportation vehicle of the autonomous transportation vehicle fleet. The service module is configured to maintain the operating capacity of the transportation vehicle as part of the transportation vehicle fleet.

### BRIEF DESCRIPTION OF THE DRAWINGS

Exemplary embodiments will be explained hereafter by reference to the associated drawings. Shown are:

FIG. 1 shows a schematic representation of a system for carrying out the disclosed method consisting of an autonomous transportation vehicle, a server of a fleet operator and a service station;

FIG. 2 shows a schematic representation of a first service module for cleaning the interior of the transportation vehicle;

FIG. 3 shows a schematic representation of a second service module for cleaning the exterior of the transportation vehicle;

FIG. 4A shows a schematic representation of a third service module for filling an energy store of the transportation vehicle;

FIG. 4B shows a schematic representation of a charging connection for refilling an energy store of the transportation vehicle;

FIG. 5 shows a schematic representation of a disclosed service station in accordance with a first embodiment;

FIG. 6 shows a schematic representation of a disclosed service station in accordance with a second embodiment; and

FIG. 7 shows a schematic representation of a disclosed service station in accordance with a third embodiment.

### DETAILED DESCRIPTION

Modern transportation vehicles already have a plurality of assistance systems which provide computer based support for the driver in a large number of driving situations. Such assistance systems can rely on sensors for capturing a plurality of measurement data, which far exceed the capabilities of the human senses. In addition the speed of these assistance systems significantly exceeds human reaction times. Known driver assistance systems are, for example, lane departure warning systems, brake assist systems with pedestrian detection and adaptive cruise control, in particular. for congestion situations.

By the application of such assistance systems, the autonomy of the driver with regard to driving decisions is being increasingly transferred to the transportation vehicle, or control units operating therein. The ultimate goal of these developments is an autonomously driving transportation vehicle which can maneuver completely without human intervention. Such a self-driven transportation vehicle enables a fully automated passenger transport. To date, such self-driven transportation vehicles have only usually been approved for specific individuals and/or have no approval for road use without additional monitoring by a driver. In terms of maintenance and servicing these autonomously driven transportation vehicles therefore differ little from other privately owned transportation vehicles. As a rule, the owner or owners take care of the maintenance and energy supply of the transportation vehicle.

A wide variety of mobility concepts already exist today, however, particularly in urban areas. In a so-called car-sharing system, a plurality of users can access the transportation vehicles of a fleet of transportation vehicles independently of each other and for limited periods. By the fleet transportation vehicles only being tied to a specific user for the period of the actual usage, the unused time that the transportation vehicles are parked can be minimized. Such concepts are also known for other transportation vehicles, such as bicycles, scooters or vans. In the following the term car sharing is used to represent such concepts for all types of transportation vehicle, and is not limited to passenger cars.

A distinction is made between centralized and decentralized car-sharing systems. In centralized car-sharing systems the transportation vehicle use must always begin and end at fixed stations. This is therefore essentially a temporary form of classical transportation vehicle rental. In decentralized car-sharing systems, on the other hand, the transportation vehicle use can begin and end at any point in an operating area covered by the fleet provider. Decentralized car-sharing systems have the potential to significantly reduce the total number of transportation vehicles needed, since above a sufficient number of users and transportation vehicles the transportation fleet vehicles will be available in a self-organized manner and with a sufficient density in the operating area of the car-sharing fleet provider.

Particularly in the case of decentralized car-sharing concepts, however, the energy supply, maintenance and servicing of the transportation vehicles is a challenge. One possibility is to use employees of the fleet provider for refueling and cleaning the transportation fleet vehicles. This significantly increases the personnel costs, however, and therefore the cost of the car-sharing system. Alternatively, the users of the autonomous transportation vehicles can be encouraged to carry out necessary service visits by providing appropriate incentives. In this case, however, there is a risk of inadequate maintenance or transportation vehicle breakdowns.

In the context of the present application the term car-sharing will be understood in the broader sense to also include ride-pooling and ride-hailing. An autonomous transportation vehicle fleet can therefore also be a fleet of private transportation vehicles which are only temporarily made available for transport services, in particular, for autonomous driving services. In these and similar cases, a fleet operator is understood to mean the provider of an application, wherein the application is used to connect users and providers of transport services.

Disclosed embodiments overcome or at least reduce the problems of the prior art and to provide a solution for the maintenance and servicing of autonomous transportation fleet vehicles. This is achieved by a method and a service module.

A first disclosed embodiment relates to a method for operating an autonomous transportation vehicle fleet, in other words for operating a fleet of autonomous transportation vehicles. In the context of the present disclosure, each transportation vehicle of the fleet is designed (configured) for autonomous driving operation. In particular, each autonomously driven transportation vehicle of the transportation vehicle fleet has at least one first sensor designed for collecting environment data and at least one second sensor designed for collecting transportation vehicle data. The at least one first sensor enables collection of surroundings or environment information and the at least one second sensor allows collection of information about the transportation vehicle itself. Each of the transportation vehicles also has a driving system designed to perform autonomous driving maneuvers. The driving system may be designed for the full transverse and longitudinal guidance of the transportation vehicle. In addition, each of the transportation vehicles has a (first) communication module for establishing at least one communication connection. The (first) communication module is, for example, a WLAN or mobile wireless module and may be designed to perform a Car2Car or Car2X communication. In addition, each of the transportation vehicles has at least one energy store, such as a battery system and/or a fuel or hydrogen tank. The individual transportation vehicles in the transportation vehicle fleet and their aforementioned components are either identical to each other or different from each other.

In the disclosed method for operating a fleet of such autonomous transportation vehicles a service requirement of at least one transportation vehicle of the transportation vehicle fleet is first identified. In other words, in a first operation information relating to a status property of a transportation fleet vehicle is determined, indicating that an actual state of the transportation vehicle fleet differs from a target state of the same in a particular property. In so doing, the target state can apply to all or only specific transportation vehicles in the fleet, or can be specified individually.

The type of service requirement is generally predetermined by the type or classification of the target state. In addition, however, the type of service requirement can also be defined by transportation vehicle-specific properties such as the existence of an electric motor and/or internal combustion engine, which are then taken into account in the determination. In the disclosed method a degree of the service requirement may also be identified.

In the context of the present application an identified service requirement of at least one transportation vehicle may be understood to mean that the transportation vehicle was found to be dirty. The dirt can affect the interior or the exterior of the transportation vehicle. It is also optional that an identified service requirement of the transportation vehicle is an identified low fill level of the energy store of the transportation vehicle, thus, for example, a low state of charge, SOC, or a low fill level of a tank for fossil fuels or hydrogen. The identified service requirement is also optionally a determined fault message from the transportation vehicle, particularly an OBD2 fault message.

A degree of the service requirement in the above-mentioned forms of implementation relates, for example, to a degree of dirt contamination (interior or exterior), the existence of an alternative energy store (as in a hybrid transportation vehicle) or the nature of the reported fault (such as in the case of a distinction between a red and a yellow warning light).

The identification of the service requirement in the disclosed method may be carried out automatically, for example, by transportation vehicle-specific data captured by the at least one second sensor. For example, a transportation vehicle control unit can output an OBD2 fault code if a self-diagnosis indicates a malfunction. Alternatively or additionally the identification of the service requirement may also be carried out on the basis of a user input. For example, a user can indicate that a transportation vehicle interior is dirty. Alternatively, a transportation vehicle user can confirm the existence of an automatically identified service requirement by providing an appropriate user input, for example, in response to an appropriate input prompt. The user input may be made in the transportation vehicle itself or by a peripheral device connected to the transportation vehicle, such as a smartphone belonging to a user of the autonomous transportation vehicle.

In the next operation of the disclosed method, a service action to be carried out on the transportation vehicle is identified on the basis of the service requirement identified for the transportation vehicle. A service action in its most general form describes an action on the transportation vehicle to transfer it from the currently existing actual state into a desired target state. A nature of the service action may be identified based on the nature of the identified service requirement. Consequently, in the context of the present application a service action is understood to mean an action applied to the transportation vehicle which corresponds to a specific service requirement. The operation that corresponds to a contamination of the transportation vehicle with dirt, for example, is cleaning the transportation vehicle. The operation corresponding to a low level of the energy store is refilling the energy store. The operation corresponding to a detected fault message of the transportation vehicle may be a maintenance or repair of the transportation vehicle. The degree of a service action is identified based on the degree of the identified service requirement. For example, on the basis of a contamination level it is determined whether an exterior or interior cleaning should be carried out, the latter possibly with or without upholstery cleaning. Also, the level of a fault message indicating too low air pressure of a tire may be used to determine whether re-inflation of the tire or its replacement is necessary.

In the context of the disclosed method, the at least one service action may be identified by the autonomous transportation vehicle itself. Alternatively, the service action is identified by a server of a fleet operator, to which information relating to the service requirement was previously sent from the transportation vehicle. The service action may also be identified by at least one service station, to which information relating to the service requirement was previously sent from the transportation vehicle.

Optionally, the at least one service action is identified automatically, for example, using a database, by at least one look-up table, LUT, by at least one algorithm and/or by an artificial intelligence system. Alternatively or additionally the at least one service action may be determined wholly or partly on the basis of a user input, for example, in response to an input prompt. The user in this case is, for example, a transportation vehicle user or an employee of the fleet operator.

In a next operation of the disclosed method a service station suitable for performing the identified service action is determined. In the context of the present application, a suitable service station is a service station configured (designed) for performing the identified service action. The suitable service station is suited for performing the service action either fully or partly autonomously. Autonomous performance is understood to mean the performance of the action without human intervention (apart from programming, maintenance and servicing of the service station). The suitability of the service station is determined on the basis of the facilities of the same, hence on the basis of the service modules available in the service station. In the context of the present application a service module is designed to perform at least one service action, such as cleaning, refilling an energy store and/or performing maintenance or repairs.

The disclosed method may be implemented as part of a service infrastructure having a plurality of service stations which are distributed in an operating area of the autonomous transportation vehicle fleet. The number and density of the service stations may be matched to the number of autonomous transportation fleet vehicles, the demand for service actions or the frequency of required service actions. Each of the service stations may be designed for communication with the autonomous transportation vehicles, with a server of the fleet operator and/or with other service stations. The configuration of the service stations is explained in detail in the following.

In the context of the disclosed method the suitable service station may be identified by a server of a fleet operator which has access to information on the equipment of the service stations, to which information about the utilization of the service stations has been sent and/or to which the information about the service requirement of at least one transportation vehicle has been sent. The suitability may also be identified by at least one service station itself, to which information relating to a required service action or a service requirement of a transportation vehicle has been sent from a transportation vehicle or the server. The service station may take its own utilization into account. In each of the aforementioned forms of implementation, the suitability may be identified automatically, for example, using a database, by at least one look-up table, LUT, by at least one algorithm and/or by an artificial intelligence system. Alternatively or additionally the at least one suitable service station may be determined partly on the basis of a user input, for example, by an employee of the fleet operator, in response to an input prompt.

In the next operation of the disclosed method the transportation vehicle drives autonomously to the identified suitable service station. The journey takes place immediately after an appropriate service station has been determined or at a specific time. The specific time may be a time which usually has a low utilization, such as early in the morning or similar. The performance of the autonomous driving may also depend on an actual utilization of the transportation vehicle. The performance of the autonomous drive may also depend on an estimated duration of the identified service action and/or the utilization of the service station. A user input can also be taken into account in the decision to perform the autonomous driving. The drive to the service station may take place at a time at which any impairment of the fleet operation due to the breakdown of the transportation vehicle concerned is minimal. Depending on the type and/or degree of the service requirement identified or the identified service action, however, the journey may also be undertaken by a transportation vehicle transporter which collects the autonomous transportation vehicle concerned and transports it to the appropriate service station.

Provided that the autonomous transportation vehicle concerned arrives at the identified and appropriate service station, the identified service action corresponding to the service requirement is performed on the transportation vehicle in and by the service station partly or fully autonomously. In other words, the service station has at least one device which is designed to perform the service action. The device may be designed as a robotic device, which requires either no or only minimal action by a user. The service action may take place in the service station fully automatically. If in the disclosed method only the nature of the service requirement and the service action have been identified in advance, the degree of the service requirement and the service action may also be determined in the service station. For example, the degree of the contamination of the autonomous transportation vehicle and hence an intensity of cleaning may not be determined until entering a service station designed for cleaning. Also, the autonomous performance of the service action additionally comprises the inspection of the quality of the autonomously performed service action. For example, in the service station, after performing the service action it can be checked again whether an actual state of the transportation vehicle corresponds to the desired target state. If the autonomous performance of the service action is completed, at least if the inspection of the service result has been successfully passed, the autonomous transportation vehicle can return to operation in the autonomous transportation vehicle fleet. If the inspection is not successful, the same or a different service action may have to be performed.

The disclosed method enables a long-term operation of an autonomous transportation vehicle fleet by maintaining the operational capability of the transportation fleet vehicles. The operational capability can relate both to the actual physical operational capability, for example, depending on a fill level of the energy store, and to the operational capability for commercial use, for example, depending on a degree of contamination of the transportation vehicle. The disclosed method integrates the use of autonomous operating depots into the use of an autonomous transportation vehicle fleet, in particular, for cleaning, refueling and maintenance of the transportation vehicles. As the detection of a service requirement, the selection of a service station and the journey to the service station are carried out autonomously, the personnel expenses can be kept to a minimum.

In an exemplary embodiment, the disclosed method also comprises one or more of the following method operations. Optionally, the service requirement is identified on the basis of a user input and/or on the basis of transportation vehicle data of the transportation vehicle. For example, a transportation vehicle-mounted sensor is used to detect a low fill level of the energy store. A degree of contamination of the transportation vehicle may also be determined by a user input, for example, via a smartphone app or an input via an instrument cluster of the transportation vehicle. In addition the service requirement of the transportation vehicle may be transferred to a server of a fleet operator and/or to at least one service station. The transfer may be carried out by telecommunication from the transportation vehicle or, in particular, in the above example directly from a user's smartphone. The transfer may be carried out by a message which contains information relating to the identified service requirement. The message has a suitable format.

In the disclosed method the identification of the service action corresponding to the service requirement may also be carried out by the server or by the at least one service station. The identification may be based on information previously received from the transportation vehicle or from the user (smartphone). The server and/or the service station may have appropriately configured control units for this purpose. The service station and/or the server also each have a communication module for receiving the corresponding information. Also in the disclosed method, information on the at least one identified service station may be transferred to the transportation vehicle from the server or from a service station. The information includes details about the location, facilities and/or utilization of the service station. The autonomous transportation vehicle performs the drive to the suitable service station based on this transferred information.

Also, in at least one exemplary embodiment of the disclosed method a suitable service station may be identified depending on the utilization of the service station. In this regard, of a plurality of identically equipped service stations, a service station with lower utilization has a higher suitability than a service station with higher utilization. The information on the utilization of the service station may exist in the service station itself or is transferred from this to a server of the fleet operator. Also, in at least one exemplary embodiment of the disclosed method a suitable service station may be identified depending on the distance between the relevant transportation vehicle and the at least one service station. Normally, a service station is more suitable the closer it is to the transportation vehicle in question. Depending on the utilization of the individual service stations, however, a service station further away from the transportation vehicle can also be the most suitable for performing the service.

The operations of the disclosed method can be implemented either by electrical or electronic parts or components (hardware), by firmware (ASIC) or by executing a suitable program (software). The disclosed method may also be realized or implemented by a combination of hardware, firmware and/or software. For example, individual components for performing individual operations of the method are implemented as a separate integrated circuit or arranged on a common integrated circuit. Individual components configured for performing individual operations of the method may also be arranged on a (flexible) printed circuit substrate (FPCB/PCB), a Tape Carrier Package (TCP) or other substrate.

The individual operations of the disclosed method may also be implemented as one or more processes which run on one or more processors in one or more electronic computing devices and are generated when executing one or more computer programs. For this purpose the computing devices may be designed to cooperate with other components, for example, a communication module and one or more sensors or cameras, to achieve the functionality described herein. The instructions of the computer programs may be stored in memory, such as a RAM element. The computer programs can also be stored in a non-volatile storage medium, such as a CD-ROM, flash memory or the like.

It will also be clear to the person skilled in the art that the functionalities of a plurality of computers (data processing devices) can be combined or can be combined in a single device, or that the functionality of a particular data processing device can be distributed over a plurality of devices to execute the operations of the disclosed method, without departing from the previously described method.

A further disclosed embodiment relates to a service station for the transportation vehicles of an autonomous transportation vehicle fleet, in particular, for transportation fleet vehicles as described in the introduction. The service station may be designed for use in a disclosed method, as described above. To this end, a disclosed service station may have a (second) communication module which is configured for communication with the transportation vehicles and/or a server of a fleet operator. The (second) communication module is, for example, a WLAN or mobile wireless module and may be designed to perform a Car2Car or Car2X communication. The second communication module may be designed to communicate in accordance with a communication protocol used by the first communication module and/or by the server.

The disclosed service station also comprises a second control unit, which is configured for determining a service action to be carried out on a transportation vehicle. The control unit is designed to determine the service action on the basis of information relating to a service requirement of the transportation vehicle. The second communication module may be designed to receive information on this service requirement from a transportation vehicle and/or the server. Furthermore, the disclosed service station has at least one service module designed to perform a service action on the transportation vehicle autonomously. The service module may be designed as a robot, or comprises robotics. The specific design of the service modules of the service station may vary.

In an exemplary embodiment, the disclosed service station is designed to identify the service action to be performed on the basis of received or acquired information about a service requirement of the transportation vehicle. The second control unit is configured to identify at least one service action to be performed on the transportation vehicle on the basis of information that was received from the transportation vehicle or from the server by the second communication module.

The second control unit may also be designed to identify a service requirement and/or a service action for the transportation vehicle on the basis of transportation vehicle-specific variables that were acquired from a first control module. Data received from the transportation vehicle and/or from the server may also be combined with data collected in the service station to determine the type and/or the degree of the service action to be performed on the transportation vehicle. If the service station has already been identified beforehand as a suitable station for cleaning a transportation vehicle, optionally upon the arrival of the transportation vehicle the degree of contamination of the transportation vehicle is detected to determine the type and degree of cleaning, such as interior or exterior cleaning, upholstery cleaning, disinfection etc.

In an exemplary embodiment, the disclosed service station has at least one first service module designed to perform an interior cleaning of the transportation vehicle. The first service module may be a robot arm which is fitted with tools suitable for the interior cleaning of the transportation vehicle. The robot arm may be designed to be introduced into the transportation vehicle interior through an open door or an open window of the transportation vehicle. The tools can be, for example, a vacuum cleaner nozzle, an upholstery brush, an applicator for the application of cleaning agents and/or ways for cleaning shelves and/or windows.

In another exemplary embodiment, the first service module has a mobile cleaning robot, which is designed to penetrate into a transportation vehicle interior through an open door or an open window of the transportation vehicle. The mobile cleaning robot may also have tools suitable for interior cleaning, such as a vacuum cleaner nozzle, an upholstery brush, an applicator for applying the cleaning agents and/or ways for cleaning shelves and/or windows. The mobile cleaning robot is also designed to perform an interior cleaning autonomously and/or with doors and windows closed.

As an alternative or in addition, the disclosed service station also may have at least one second service module designed to perform an external cleaning of the transportation vehicle. The second service module may be implemented as an automatic car wash known from the prior art and may have nozzles for applying at least one cleaning fluid, brushes or cloths for removing dirt from the transportation vehicle and/or a hot-air blower for drying the transportation vehicle. The second service module also has additional washing items, such as brushes specially designed for washing wheel rims and/or ways for applying wax. The second service module may also a method or mechanism for transporting the transportation vehicle in the module.

As an alternative or in addition, the disclosed service station may also have a third service module, which is designed to fill the energy store of the transportation vehicle. The third service module has its own energy storage device, such as a battery or fuel tank, or a connection to an appropriate power supply network, for example, to an electrical mains supply or to a fuel supply line. In addition, the third service module has a connection module for connection to a refilling element of the transportation vehicle. The refilling element of the transportation vehicle is, for example, a fuel filler neck or a charging socket. In addition, the connection module may have a robot arm which has a filling element which is matched to the refilling element of the transportation vehicle. The filling element may be connected to the energy store via a supply line. The third service module may be designed for hybrid transportation vehicles and comprises, for example, a first filling element connected to the mains electricity supply for connection to a charging socket of the transportation vehicle, and a second filling element connected to a fuel supply line for connection to a fuel filler neck of the transportation vehicle. In addition to the first, second and third service module, a disclosed service station can have one or more further service modules.

In another exemplary embodiment of the disclosed service station the first, second and third service module are arranged in a common area of the service station. All service modules may be arranged in the service station in such a way that they can perform their functions on a transportation vehicle located in the service station without any movement of the transportation vehicle in the station being necessary. In such a service station an interior cleaning, an exterior cleaning and a refilling of the energy store of a transportation vehicle are carried out sequentially or in parallel on a transportation vehicle located in the service station, without requiring any movement of the transportation vehicle. According to this disclosed embodiment the second control unit may be configured to initiate the autonomous entry of the transportation vehicle into the service station, for example, by communicating with the control unit/driving system by the communication modules. Alternatively the autonomous driving of the transportation vehicle to the service station may end on a conveyor belt of the same and the autonomous entry of the transportation vehicle into the station may include transporting the transportation vehicle by the conveyor belt.

According to this disclosed embodiment, the second control unit may also be configured to initiate an interior cleaning of the transportation vehicle by the first service module if at least one door of the transportation vehicle is open. The interior cleaning may be initiated by introducing the mobile cleaning robot, whereupon the door is closed again. Alternatively, the transportation vehicle cleaning is performed by a robot arm through the open door of the transportation vehicle. The second control unit may also be configured to perform an interior cleaning of the transportation vehicle by the second service module if at least one door of the transportation vehicle is open. The external cleaning of the transportation vehicle can thus be performed while the mobile cleaning robot cleans the inside of the transportation vehicle. Alternatively, the external cleaning can be carried out before or after the internal cleaning. The second control unit may also be configured to fill the energy store of the transportation vehicle by the third service module. The filling of the energy store is carried out simultaneously with or temporally staggered relative to the interior and/or exterior cleaning. If the refilling comprises recharging of an electrical energy store, the risk of short-circuits due to any of the cleaning fluids used must be taken into account. This can be achieved by appropriate positioning of the refilling unit on the transportation vehicle, for example, on the underbody, or by temporally staggering the cleaning.

In another exemplary embodiment of the disclosed service station the first service module, the second service module and/or the third service module are arranged in different areas of the service station. According to this disclosed embodiment therefore, at least one movement of the transportation vehicle is necessary between the implementation of the various service actions. According to an exemplary embodiment, all service modules are arranged in the service station separately from one another, the design of the service station is therefore completely modular. In each of the service modules the appropriate service action is carried out and this is followed by the transportation vehicle moving to the next module. The movement of the transportation vehicle can be performed autonomously or by the service station.

In another disclosed embodiment, the second service module is arranged separately and the first service module and the third service module are arranged in a common area of the service module. Therefore, before or after the exterior cleaning of the transportation vehicle, the filling of the energy store and an interior cleaning of the transportation vehicle are carried out at the same time. Here also, a movement of the transportation vehicle between modules is necessary, in particular, between the exterior cleaning and the combined charging and interior cleaning. This movement is carried out either autonomously or by the service station.

In accordance with this disclosed embodiment, the second control unit may be configured to initiate the autonomous entry of the transportation vehicle into a first area of the service station. For example, the second control unit communicates with the control unit/driving system of the transportation vehicle via the communication modules. Alternatively, the autonomous driving of the transportation vehicle to the service station ends on a conveyor belt of the service station and the autonomous entry of the transportation vehicle may include transporting the transportation vehicle into the service station by the conveyor belt. The second control unit is configured to control and/or to initiate an autonomous movement of the transportation vehicle from the first area to a second area of the service station. The initiation may be carried out via a communication with the driving system of the transportation vehicle, to start an autonomous drive of the transportation vehicle. Alternatively, the transport can be initiated by operation of a conveyor belt of the service station without any independent movement of the transportation vehicle. The first area may comprise at least one of the first, second and third service modules and the second area may have at least one other of the first, second and third service modules. The service modules in the first area are thus different from the modules arranged in the second area.

In another exemplary embodiment of the disclosed service station, this additionally has a first control module upstream of the service modules. The first control module has at least a third sensor, which is designed to capture at least one variable which characterizes a service requirement of the transportation vehicle. In other words, the first control module is designed (configured) to detect at least one service requirement of the transportation vehicle. Thus, a previously detected service requirement, or a service action identified from it, can be verified and modified. In another exemplary embodiment of the disclosed method, only a type of the service requirement or a type of the service action corresponding thereto is determined in advance. In this case, on the basis of information collected by the first control module, a level of the service requirement or the associated service action is determined.

In an exemplary embodiment the first control module is designed as a scan bridge or the like. The first control module may also have at least one sensor, for example, an optical sensor such as a camera, for detecting contamination of the transportation vehicle. Also, the first control module may have a method or mechanism for reading out a fill level of an energy store of the transportation vehicle and/or ways for reading an error message of the transportation vehicle. The first control module may also be designed for additionally capturing a plurality of transportation vehicle-specific information (independently of a service requirement). The first control module may be designed to capture a transportation vehicle type, a transportation vehicle size, the presence of objects (loading, child seat, documents, etc.) in the transportation vehicle, setting values of adjustable transportation vehicle components (seats, mirrors, etc.) and the like. The second control unit may be designed to adjust the service action on the basis of the additional transportation vehicle-specific information collected. For example, a cleaning operation of the transportation vehicle can be adjusted as a function of the size of the transportation vehicle or be carried out in such a way that a user's objects cannot be removed from the transportation vehicle. Also, after completion of the service action the detected initial positions of transportation vehicle components, such as seating positions, may be restored.

In another exemplary embodiment of the disclosed service station, this additionally has a second control module located downstream of the service modules. The second control module has at least a fourth sensor, which is designed to capture at least one variable which characterizes the service requirement of the transportation vehicle. In other words, the second control module is also designed to detect at least one service requirement of the transportation vehicle. However, this detection is used, in particular, to evaluate the quality of the service action carried out previously. The actual state captured with the second control module can be compared with a desired target state of the service action. The second control module may be designed completely or partly identical to the first control module, for example, as a scan bridge or similar.

A further disclosed embodiment relates to a computer program comprising commands which during the execution of the program by a computer, such as a control unit of a service station, cause the latter to execute the disclosed method, the disclosed method of the service station comprising the operations of: identifying at least one service action to be performed on the transportation vehicle on the basis of information received from a transportation vehicle or from a server, or transfer of information on its own location, facilities and/or utilization to a transportation vehicle and/or to a server; initiating an autonomous driving of a transportation vehicle into the service station; and control of the autonomous performance of at least one service action on the transportation vehicle using at least one service module. Optionally, the method of the service station also comprises the operation: detecting a transportation vehicle controlling the service station to perform a service action, and/or capturing a transportation vehicle-specific variable and/or a service requirement of the transportation vehicle by a first control module and/or a second control module.

A further disclosed embodiment relates to a computer-readable storage medium comprising commands which during execution by a computer, such as a control unit of a service station, cause the latter to execute the disclosed method, the disclosed method of the service station comprising the operations of: identifying at least one service action to be performed on the transportation vehicle on the basis of information received from a transportation vehicle or from a server, or transfer of information on its own location, facilities and/or utilization to a transportation vehicle and/or to a server; initiating an autonomous entry of a transportation vehicle into the service station; and control of the autonomous performance of at least one service action on the transportation vehicle using at least one service module. Optionally, the method of the service station also comprises the operation: detecting a transportation vehicle controlling the service station to perform a service action, and/or capturing a transportation vehicle-specific variable and/or a service requirement of the transportation vehicle by a first control module and/or a second control module.

A further disclosed embodiment relates to an autonomous transportation vehicle, in particular, a passenger car having an internal combustion engine, an electric motor or hybrid engine, which has at least one first sensor configured for collecting environment data, at least one second sensor configured for collecting transportation vehicle data and a first communication module, as well as a driving system configured for autonomously driving the transportation vehicle. The communication module may have a radio, mobile radio, WLAN, and/or BLUETOOTH® transceiver or alternative wireless communication devices.

The at least one first sensor is designed to capture sensor signals relating to the environment around the transportation vehicle. The at least one second sensor is designed to capture sensor signals relating to the transportation vehicle itself. The first communication module is designed to receive information potentially relating to the transportation vehicle and/or its environment via a communication network. In this case an environment signal received by the at least one first sensor may enable the transportation vehicle to be informed about its environment and may represent a plurality of environmental information. A status signal received by the at least one second sensor may enable the transportation vehicle to be informed about its own status and to do so, represents a plurality of environmental information items.

The exemplary driving system of the disclosed transportation vehicle may be configured to perform at least one autonomous driving maneuver and/or an autonomous drive from the transportation vehicle's own position to a target position of the transportation vehicle. The driving system may be designed for the fully automatic (autonomous) guidance of the transportation vehicle and can control the longitudinal guidance and the transverse guidance of the transportation vehicle. The driving system can access the at least one first sensor and/or the at least one second sensor to determine status information and/or environment information of the transportation vehicle. These first and second sensors are therefore usable by the driving system and the first control unit.

In addition, the transportation vehicle has a first control unit designed for carrying out the disclosed method, as described above. The first control unit is configured to perform the operations associated with the transportation vehicle within the disclosed method. The first control unit is configured to identify a service requirement of the transportation vehicle on the basis of a user input and/or on the basis of transportation vehicle data of the transportation vehicle; to transfer the identified service requirement of the transportation vehicle to a server of a fleet operator and/or to at least one service station; to receive information relating to at least one identified service station from the server and/or from a service station; and by the driving system to perform an autonomous driving of the transportation vehicle to the identified service station, wherein the identified service station is suitable for performing a service action corresponding to the service requirement.

Common transportation vehicles today already have a plurality of sensors which as first sensors detect different environmental conditions, such as outside temperature, (air) humidity, etc. In addition, transportation vehicles can also already have second sensors, for example, position sensors of an anti-theft alarm system. Modern transportation vehicles are also equipped with powerful communication modules, which enable the receipt of information over a plurality of channels. The disclosed method applies these existing sensors for a new use.

A disclosed embodiment relates to a first control unit of a transportation vehicle which is configured with at least one first sensor for collecting environment data of a transportation vehicle, with at least one second sensor for collecting status data of the transportation vehicle and with a first communication module of a transportation vehicle for communicating with a driving system for autonomously driving the transportation vehicle and which is also configured to carry out the disclosed method as described above. Exemplary embodiments of the first control unit correspond to the implementation forms described above with regard to the disclosed method.

A further disclosed embodiment relates to a computer program comprising commands, which during the execution of the program by a computer, such as a first control unit of a transportation vehicle, cause the latter to execute the disclosed method of the transportation vehicle, the disclosed method of the transportation vehicle comprising: identifying a service requirement of the transportation vehicle on the basis of a user input and/or on the basis of transportation vehicle data of the transportation vehicle; transferring the identified service requirement of the transportation vehicle to a server of a fleet operator and/or to at least one service station; receiving information relating to at least one identified service station from the server and/or from a service station; and performing an autonomous driving of the transportation vehicle to the identified service station by the driving system, wherein the identified service station is suitable for performing a service action corresponding to the service requirement.

A further disclosed embodiment relates to a computer-readable storage medium comprising commands which when executed by a computer, such as a first control unit of a transportation vehicle, cause the latter to execute the disclosed method, the disclosed method comprising the following operations: identifying a service requirement of the transportation vehicle on the basis of a user input and/or on the basis of transportation vehicle data of the transportation vehicle; transferring the identified service requirement of the transportation vehicle to a server of a fleet operator and/or to at least one service station; receiving information relating to at least one identified service station from the server and/or from a service station; and performing an autonomous driving of the transportation vehicle to the identified service station by the driving system, wherein the identified service station is suitable for performing a service action corresponding to the service requirement.

Further exemplary embodiments are derived from the remaining features, referred to in the dependent claims. The various embodiments cited in this application, unless stated otherwise for each case, can be combined with one another.

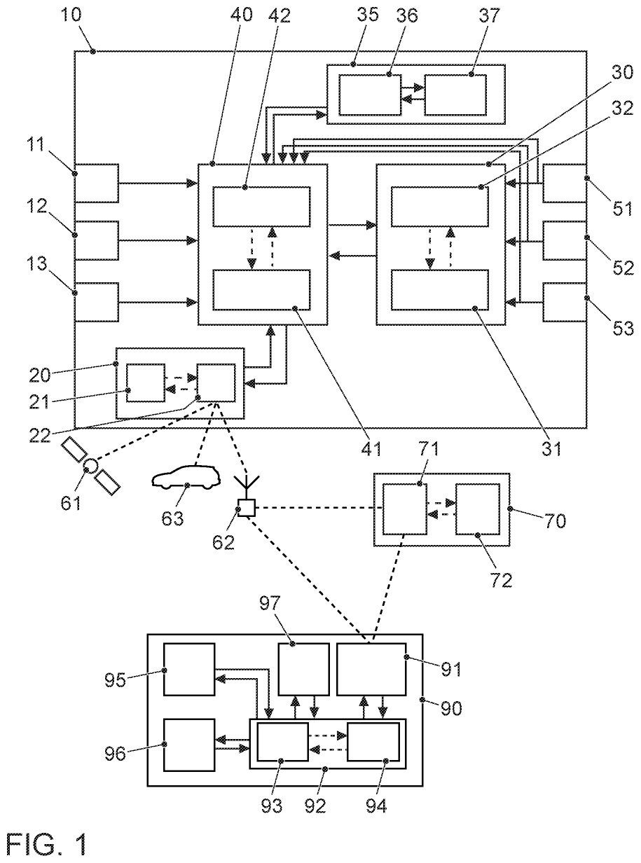

FIG. 1 shows a schematic representation of a system for carrying out the disclosed method, the system having an autonomous transportation vehicle 10, a server 70 of a fleet operator, and a service station 90.

FIG. 1 shows a block diagram of a two-track transportation vehicle 10 with electric motor 37. The transportation vehicle 10 comprises a plurality of first sensors, in particular, a first sensor 11, a second sensor 12 and a third sensor 13. The first sensors 11, 12, 13 are configured for collecting environment information or environmental data of the transportation vehicle 10 and include, for example, temperature sensors for capturing an ambient temperature, a camera for capturing an image of an environment directly surrounding the transportation vehicle 10, a microphone for capturing sounds of an environment directly surrounding the transportation vehicle 10, distance sensors such as ultrasound sensors for capturing distances to objects surrounding the transportation vehicle 10. The first sensors 11, 12, 13 transmit the environment signals captured thereby to a first control unit 40 of the transportation vehicle 10.

The transportation vehicle 10 also has a multiplicity of second sensors, in particular, a fourth sensor 51, a fifth sensor 52 and a sixth sensor 53. The second sensors 51, 52,53 are sensors for detecting status data relating to the transportation vehicle 10 itself, for example, current location and movement information of the transportation vehicle 10. The second sensors are therefore, for example, speed sensors, accelerometers, inclination sensors, interior motion detectors, pressure sensors in the transportation vehicle seats, or the like. The second sensors 51, 52, 53 transfer the status signals captured thereby to the first control unit 40 of the transportation vehicle 10. Furthermore, the second sensors 51, 52, 53 transfer their measurement results directly to a driving system 30 of the transportation vehicle 10.

The transportation vehicle 10 also has a first communication module 20 with a memory 21 and one or more transponders or transceivers 22. The transponders 22 are wireless, WLAN, GPS or BLUETOOTH® transceivers or similar. The transponder communicates with the internal memory 21 of the first communication module 20, for example, via a suitable data bus. By the transponder 22 the current position of the transportation vehicle 10, for example, can be identified by communication with a GPS satellite 61 and this can be stored in the internal memory 21. Likewise, by the transponder 22, authorization information stored in the memory 21 can also be transferred to an external communication module. The first communication module 20 communicates with the first control unit 40.

In addition, the first communication module 20 is configured to communicate with a server 70 of a fleet operator, in particular, with a fourth communication module 71 of the server 70, for example, via a UMTS (Universal Mobile Telecommunication Service) or LTE (Long Term Evolution) mobile radio network. The first communication module 20 is also configured to communicate with a second communication module 92 of a service station 90, also via a UMTS or LTE mobile radio network, for example. The communication over the wireless network takes place, in particular, via a base station 62.

The transportation vehicle 10 also comprises the driving system 30, which is configured for the fully autonomous driving operation, in particular, for the longitudinal and transverse guidance, of the transportation vehicle 10. The driving system 30 has a navigation module 32 which is configured for calculating routes between a starting point and a destination point and for determining the maneuvers to be carried out along this route by the transportation vehicle 10. In addition, the driving system 30 comprises an internal memory 31, for example, for map materials, which communicates with the navigation module 32, for example, via a suitable data bus.

At least some of the second sensors 51, 52, 53 of the transportation vehicle transfer their measurement results directly to the driving system 30. These data transferred directly to the driving system are related to current location and movement information of the transportation vehicle. These may be captured by speed sensors, accelerometers, inclination sensors, etc.

The transportation vehicle 10 also has an electric drive system 35, which provides the necessary functionalities for the electric propulsion of the transportation vehicle 10. The electric driving system 35 has an electrical energy store 36, which provides an electric motor 37 with the electrical energy necessary to propel the transportation vehicle 10. The electric drive system 35 also has a charging device, not shown, for charging the electrical energy storage unit 36. In addition, the transportation vehicle can be a hybrid transportation vehicle which has a hydrogen tank for supplying a fuel cell system arranged in the transportation vehicle 10.

The transportation vehicle 10 also has a first control unit 40 which is configured for carrying out the disclosed method. To this end, the first control unit 40 has an internal memory 41 and a CPU 42 which communicate with each other, for example, via a suitable data bus. In addition, the first control unit 40 is in communication with at least the first sensors 11, 12, 13, the second sensors 51, 52, 53, the first communication module 20 and the driving system 30, for example, via one or more respective CAN connections, one or more respective SPI connections, or other suitable data connections.

The control unit 40 is designed to execute the following operation of the disclosed method according: identifying a service requirement of the transportation vehicle 10 on the basis of a user input and/or on the basis of transportation vehicle data of the transportation vehicle 10 received by the first communication module 20; transferring the identified service requirement of the transportation vehicle 10 to the server 70 and/or to at least one service station 90 by the first communication module 20; receiving information relating to at least one identified service station 90 from the server 70 and/or from a service station 90 by the first communication module 20; and performing an autonomous driving of the transportation vehicle 10 to the identified service station 90 by the driving system 30, wherein the identified service station 90 is designed and suitable for performing a service action associated with the service requirement of the transportation vehicle 10.

The disclosed system for carrying out the disclosed method may also have a server 70 of a fleet operator. The server 70 has a (fourth) communication module 71, which is configured for communication using the same protocol as the first communication module 20 of the transportation vehicle 10. The server 70 also comprises a (fourth) control unit 72. In addition, the server 70 may comprise a memory, not shown. The control unit 72 may be designed to receive information relating to a service requirement of a transportation vehicle 10 by the communication module 71 and to use this information to identify a service action to be performed on the transportation vehicle 10. In addition, the control unit 72 may be designed to receive information relating to utilization of service stations 90 by the communication module 71, and to use this information to identify a suitable service station 90 to perform a service action.

The disclosed system for carrying out the disclosed method also has at least one service station 90 according to the disclosure. The service station 90 has a second communication module 91, which is designed for communication with the first communication module 20 of the transportation vehicle 10 and for communication with the fourth communication module 71 of the server 70. The second communication module 91 is configured for communication with the same protocol as the first communication module 20 of the transportation vehicle 10 and as the (fourth) communication module 71 of the server 70. In addition, the service station 90 has a second control unit 92 which has a memory 93 and a CPU 94, which communicate with each other via a suitable data bus, for example, a CAN bus or SPI bus.

The service station 90 also has a first service module 95, a second service module 96 and a third service module 97, which communicate with the control unit 92. The second control unit 92 is designed, in communication with the second communication module 91 and the first to third service module 95 to 97, to perform the operations of the disclosed method carried out by the service station 90.

The second control unit 92 is designed to carry out the following operations: identifying at least one service action to be performed on the transportation vehicle 10 on the basis of information received from a transportation vehicle 10 or from a server 70 by the second communication module 91, or transferring information on its own location, facilities and/or utilization to a transportation vehicle 10 and/or to a server 70 by the second communication module 91; initiating an autonomous entry of a transportation vehicle 10 into the service station 90 by the second communication module 91; and controlling the autonomous performance of at least one service action on the transportation vehicle 10 using at least one of the first to third service modules 95, 96, 97.

The method of the service station 90 may also comprise the operations of: detecting a transportation vehicle 10 controlling the service station 90 to perform a service action and/or capturing a transportation vehicle-specific variable and/or a service requirement of the transportation vehicle 10 by a first control module, not shown, of the service station 90 and/or a second control module, not shown, of the service station 90.

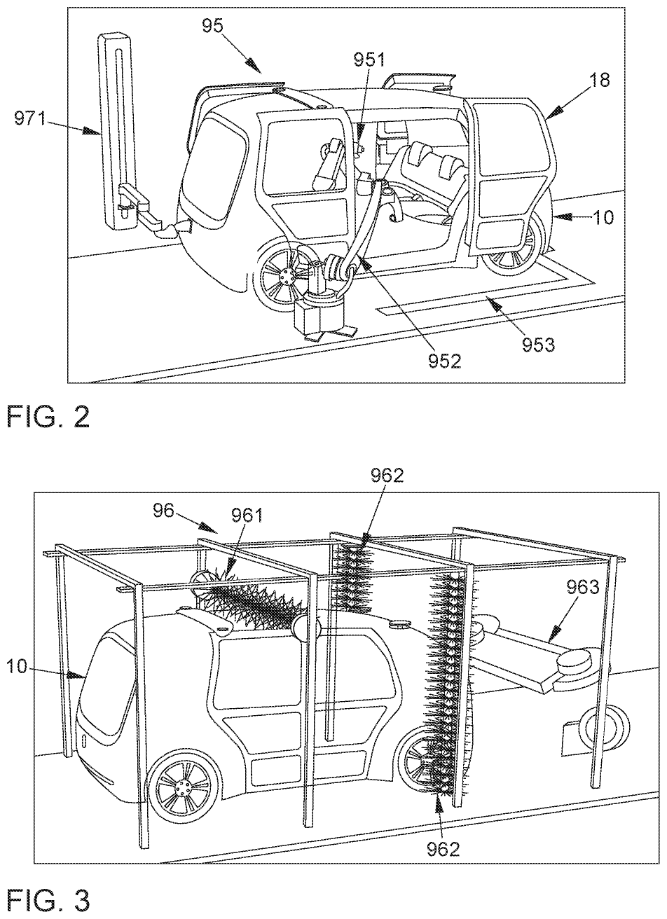

With reference to FIGS. 2 to 7, the following text contains a description of different embodiments of the service station 90 according to the disclosure and the service modules contained therein.

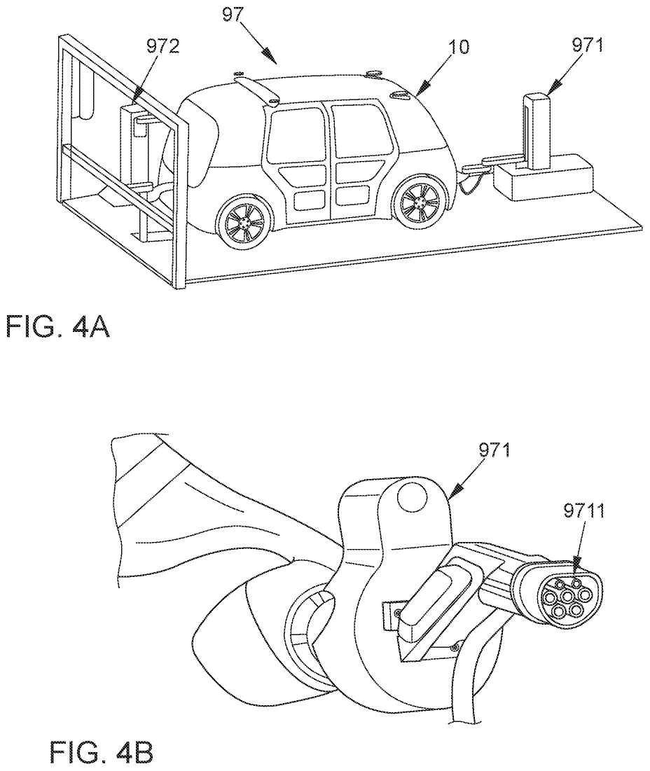

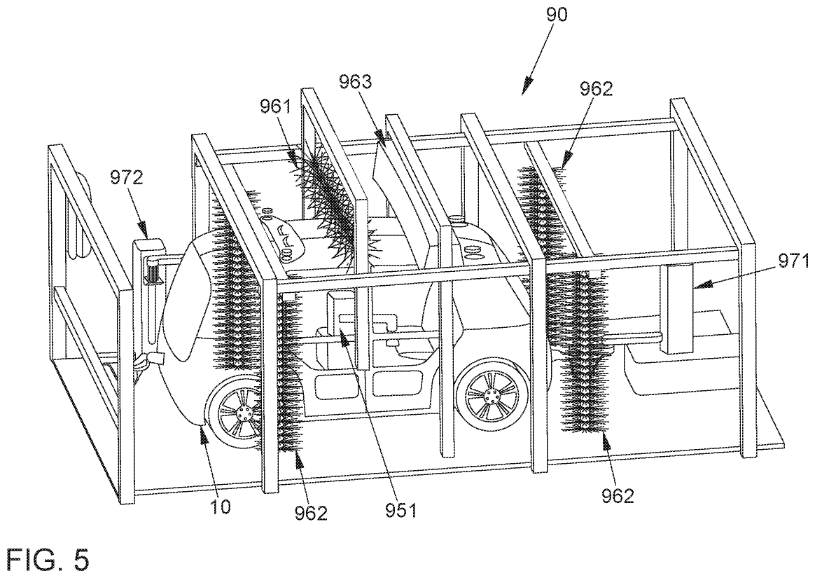

FIG. 2 shows a schematic representation of a first service module 95 for cleaning the interior of the transportation vehicle 10. To perform an interior cleaning of the transportation vehicle 10, the latter drives into the service module 95, to come to a halt there on a halt position 953. As soon as the transportation vehicle 10 comes to a halt on the halt position 953, the transportation vehicle doors 18 of the transportation vehicle 10 open automatically. This may be effected by the control unit 92 of the service station 90 or the control unit 40 of the transportation vehicle 10. As soon as the transportation vehicle doors 18 are opened, a first robot arm 951 and a second robot arm 952 are introduced into the transportation vehicle 10. Tools for performing an interior cleaning are arranged on the robot arms 951, 952, in particular, a vacuum cleaner nozzle, ways for applying a cleaning agent and ways for upholstery cleaning. The first service module 95 shown in FIG. 2 also has a charging port 971 for refilling an electrical energy store 36 of the transportation vehicle 10. The charging port 971 is described in detail below with reference to the third service module 97 and FIG. 4.

FIG. 3 shows a schematic representation of a second service module 96 for cleaning the exterior of the transportation vehicle 10. The second service module 96 largely corresponds to the automatic car washes known from the prior art for the autonomous external cleaning of a transportation vehicle 10. The third service module 96 comprises, in particular, ways not illustrated for applying a cleaning fluid, such as nozzles for applying a soap solution. In addition, the second service module 96 has a rotatable upper washing brush 961 and rotatable side washing brushes 962 for distributing the cleaning fluid and loosening the dirt. In addition, the second service module 96 has a hot air drier 963 for drying the transportation vehicle 10.

FIG. 4A shows a schematic representation of a third service module 97 for filling an energy store 36 of the transportation vehicle 10. The third service module 97 shown in FIG. 4A is designed for filling a hybrid transportation vehicle 10 with an electric motor and a fuel cell. To this end the third service module 97 has a charging port 971 for charging an electrical energy store 36 of the transportation vehicle. The charging port 971 is shown in detail in FIG. 4B and has a robot arm, at the tip of which a filling element 9711, such as a 7-pole connector, is arranged. This filling element 9711 is designed to be connected to a refilling element of the transportation vehicle 10, in particular, to a charging socket, not shown. The filling element 9711 is additionally connected via an electrical supply line to an energy network and is thus designed for feeding electrical energy into the transportation vehicle 10.

The third service module 97 also has a hydrogen fuel supply 972 for refilling a hydrogen store 36 of the transportation vehicle 10. The hydrogen fuel supply 972 also has a filling element, not shown, namely a fuel nozzle for connection to a refilling element, namely a fuel filler neck of the transportation vehicle 10. The filling element of the hydrogen fuel supply 972 is connected via a supply cable to a hydrogen store and thus designed for hydrogen refueling.

FIG. 5 shows a schematic representation of a service station 90, having the first service module 95 of FIG. 2, the second service module 96 of FIG. 3 and the fourth service module 97 of FIG. 4A according to a first disclosed embodiment. In this first disclosed embodiment of the service station 90 the first to third service modules 95 to 97 are arranged in a common area of the service station 90. The service station 90 according to this first disclosed embodiment allows the at least partially simultaneous performance of different service actions on the transportation vehicle 10.

A sequence of the autonomously performed service action in the service station 90 according to the first disclosed embodiment begins with the transportation vehicle 10 driving autonomously into the service station 90. This entrance may be implemented by the driving system 30 of the transportation vehicle 10, wherein the control unit 40 of the transportation vehicle 10 communicates by the communication modules 20, 91 with the control unit 92 of the service station 90.

If the transportation vehicle has reached a halt position in the service station 90, the doors 18 of the transportation vehicle 10 open automatically and a mobile cleaning robot moves autonomously into the interior or is introduced into the interior of the transportation vehicle 10. As soon as the doors 18 of the transportation vehicle 10 close, the mobile cleaning robot starts the interior cleaning and starts an exterior cleaning of the transportation vehicle 10 by the second service module 97, in particular, using the washing brushes 961, 962 and the hot-air drier 963.

As soon as the exterior cleaning is complete, by the charging port 971 an electrical energy store 36 of the transportation vehicle 10 is filled and the hydrogen tank of the transportation vehicle 10 is filled by the hydrogen fuel supply 972. As soon as the external cleaning and the internal cleaning are complete, the doors 18 open and the mobile cleaning robot moves out or is lifted out. Where appropriate, via cameras or other sensors, not shown, of a second control module an inspection of the internal and/or external cleaning of the transportation vehicle 10 is performed. Once this inspection is completed, the filling elements of charging port 971 and hydrogen fuel supply 972 are withdrawn and the transportation vehicle 10 drives autonomously out of the service station 90.

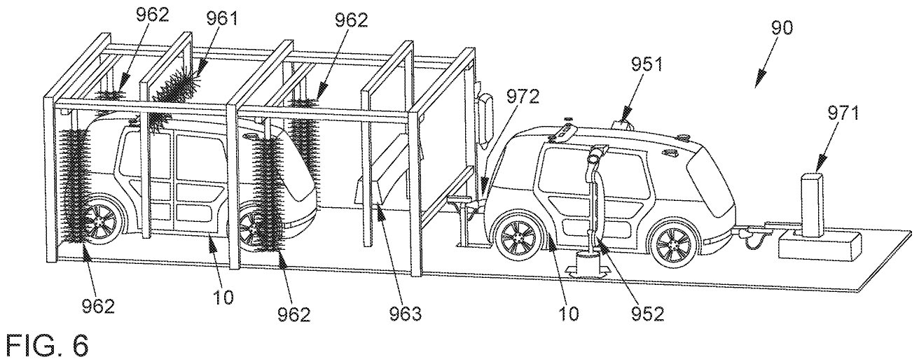

FIG. 6 shows a schematic representation of a service station 90, having the first service module 95 of FIG. 2, the second service module 96 of FIG. 3 and the fourth service module 97 of FIG. 4A according to a second disclosed embodiment. In this second disclosed embodiment of the service station 90 the first and third service module 95, 97 are arranged in a common area of the service station 90, whereas the second service module 96 is arranged upstream of the other modules 95, 97 in the service station 90. The service station 90 according to the second disclosed embodiment thus enables the internal cleaning and filling of the energy stores 36 of the transportation vehicle 10 to be performed at least partially simultaneously after cleaning the exterior of the transportation vehicle 10.

A sequence of the autonomously performed service action in the service station 90 according to the second disclosed embodiment begins with the autonomous entrance of the transportation vehicle 10 into a first area of the service station 90. This entrance may be implemented by the driving system 30 of the transportation vehicle 10, wherein the control unit 40 of the transportation vehicle 10 communicates by the communication modules 20, 91 with the control unit 92 of the service station.

If the transportation vehicle 10 has reached a stop position in the first area of the service station 90, the external cleaning of the transportation vehicle 10 begins by the second service module 96 arranged in the first area, in particular, by the washing brushes 961, 962 and the hot air drier 963. As soon as the external cleaning is completed, if applicable using cameras or sensors not shown, an inspection of the external cleaning of the transportation vehicle 10 is performed. As soon as the external cleaning and/or the inspection is completed, the transportation vehicle 10 drives autonomously to a second area of the service station 90 downstream of the first area, or is transported by a conveyor belt of the service station 90 from the first to the second area.

If the transportation vehicle has reached a halt position in the second area of the service station 90, the doors 18 of the transportation vehicle 10 open automatically and robot arms 951, 952 move autonomously into the interior. Using tools located on the robot arms 951, 952 an interior cleaning of the transportation vehicle 10 begins. At the same time, by the charging port 971 an electrical energy store 36 of the transportation vehicle 10 is filled and the hydrogen tank of the transportation vehicle 10 is filled by the hydrogen fuel supply 972.

As soon as the interior cleaning has been completed, the robot arms 951, 952 are moved out of the transportation vehicle 10. Where appropriate, using cameras or other sensors, not shown, of a second control module an inspection of the interior cleaning of the transportation vehicle 10 is performed. Once this inspection is completed, the filling elements of charging port 971 and hydrogen fuel supply 972 are withdrawn and the transportation vehicle 10 drives autonomously out of the service station 90. In an alternative disclosed embodiment the hot-air drier 963 is arranged in the second area and the transportation vehicle 10 is dried in parallel with the interior cleaning and the filling of the energy store 36.

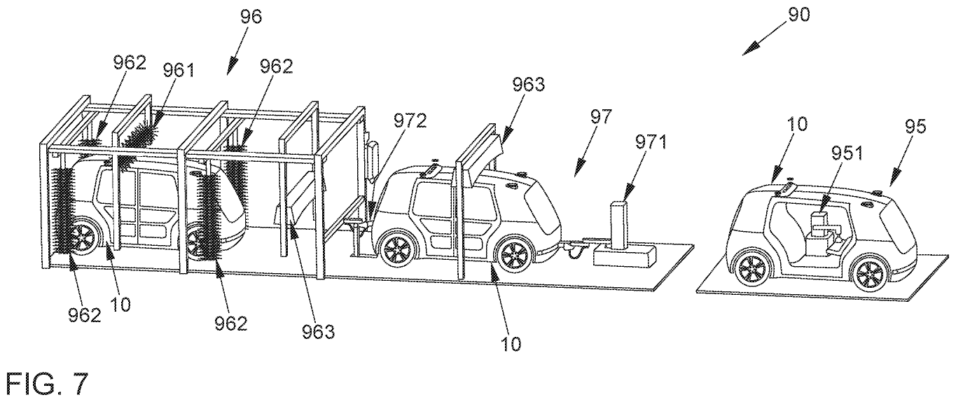

FIG. 7 shows a schematic representation of a service station 90, having the first service module 95 of FIG. 2, the second service module 96 of FIG. 3 and the fourth service module 97 of FIG. 4A according to a third disclosed embodiment. In this third disclosed embodiment of the service station 90, each of the first to third service modules 95, 96, 97 is arranged in a common area of the service station 90. The service station 90 according to the third disclosed embodiment is therefore composed of the individual service modules 95, 96, 97 in a modular state in a simple manner. The implementation of the individual service actions therefore takes place successively in a simple manner with no particular restrictions. The transportation vehicle 10 drives autonomously into the individual service modules 95, 96, 97 one after the other or else is transported between the service modules 95, 96, 97 by conveyor belts. In the individual service modules 95, 96, 97 the respective service procedures are performed. Where appropriate, a quality control of the service actions performed is carried out.

### LIST OF REFERENCE NUMERALS

10 transportation vehicle
11 first sensor
12 second sensor
13 third sensor
18 transportation vehicle door
20 first communication module
21 memory
22 transponder
30 driving system
31 memory
32 CPU
35 electric drive system
36 mechanical energy store
37 electric motor
40 first control unit
41 memory
42 CPU
51 fourth sensor
52 fifth sensor
53 sixth sensor
61 GPS satellite
62 mobile radio station
63 other transportation vehicle
70 server
71 fourth communication module
72 fourth control unit
90 service station
91 second communication module
92 second control unit
93 memory
94 CPU
95 first service module
951 cleaning robot
952 cleaning robot
953 halt position
96 second service module
961 upper washing brush
962 lateral washing brush
963 hot-air drier
97 third service module
971 charging port
972 hydrogen fuel supply

1. A service station for transportation vehicles of an autonomous transportation vehicle fleet, the service station comprising:
a communication module for communication with the transportation vehicles and/or a server of a fleet operator;
a control unit for identifying a service action to be carried out on a transportation vehicle of the autonomous transportation vehicle fleet; and
at least one service module for autonomously performing a service action on the transportation vehicle of the autonomous transportation vehicle fleet.

2. The service station of claim 1, wherein the control unit determines at least one service action to be performed on the transportation vehicle based on information received from the transportation vehicle or from the fleet operator server.

3. The service station of claim 1, wherein the at least one service module includes a first service module to perform an internal cleaning of the transportation vehicle of the autonomous transportation vehicle fleet, a second service module to perform an external cleaning of the transportation vehicle of the autonomous transportation vehicle fleet, and/or a third service module to fill the energy store of the transportation vehicle of the autonomous transportation vehicle fleet.

4. The service station of claim 3, wherein the first, second and/or third service module is/are arranged in a common area of the service station and the control unit is configured to:
initiate the autonomous entry of the transportation vehicle of the autonomous transportation vehicle fleet into the service station;
initiate an interior cleaning of the transportation vehicle of the autonomous transportation vehicle fleet by the first service module in response to at least one vehicle door of the transportation vehicle being open;
perform an external cleaning of the transportation vehicle of the autonomous transportation vehicle fleet by the second service module in response to at least one vehicle door of the transportation vehicle being closed; and
fill the energy store by the third service module.

5. The service station of claim 3, wherein the first, second and/or third service module are arranged in different areas of the service station and the control unit is configured to:
initiate the autonomous entry of the transportation vehicle of the autonomous transportation vehicle fleet into a first area of the service station; and
control and/or initiate the autonomous entry of the transportation vehicle of the autonomous transportation vehicle fleet from the first area having at least one of the first, second and third service module, to a second area having at least one other of the first, second and third service module.

6. The service station of claim 1, further comprising:
an additional control module located upstream of the at least one service module and having at least one sensor configured to capture at least one variable characterizing the service requirement of the transportation vehicle, and/or
a further additional control module located downstream of the at least one service module and having at least one sensor configured to capture a variable characterizing the service requirement of the transportation vehicle.

7. A method for operating an autonomous transportation vehicle fleet, the transportation vehicle fleet having a plurality of autonomously driven transportation vehicles, each having at least one first sensor for collecting environment data, at least one second sensor for collecting transportation vehicle data, a driving system to perform autonomous driving maneuvers, a first communication module configured to establish at least one communication connection and at least one energy store, the method comprising:
identifying a service requirement of at least one transportation vehicle of the transportation vehicle fleet;
identifying a service action to be carried out on the transportation vehicle of the autonomous transportation vehicle fleet based on the service requirement identified for the transportation vehicle;
identifying a suitable service station for performing the service action;
autonomously driving the transportation vehicle to the identified service station; and
autonomously performing the service action on the transportation vehicle in the service station.

8. The method of claim 7, further comprising:
identifying the service requirement based on a user input and/or based on transportation vehicle data of the transportation vehicle;
transferring the service requirement of the transportation vehicle to a server of a fleet operator and/or to at least one service station;
determining the service action by the server and/or by the at least one service station; and
transferring information relating to the at least one identified service station to the transportation vehicle from the server, or from a service station.

9. The method of claim 7, further comprising:
determining the service station for the service action based on utilization of the at least one service station and/or based on distance between the transportation vehicle and the at least one service station.

10. The method of claim 7,
wherein the service requirement is at least one of a contamination of the transportation vehicle with dirt, a low fill level of the energy store and a fault indication of the transportation vehicle, and/or
wherein the service action is at least one appropriate action from a cleaning of the transportation vehicle, a refilling of the energy store and a servicing or repair of the transportation vehicle.
